(19) United States
(12) Patent Application Publication
(10) Pub. No.: US 2015/0071323 A1
(43) Pub. Date: Mar. 12, 2015

(54) APPARATUS FOR IDENTIFYING MORPHOLOGY

(71) Applicant: Innolux Corporation, Miao-Li County (TW)

(72) Inventors: I-Che LEE, Chu-Nan (TW); Te-Yu LEE, Miao-Li County (TW); Yu-Tsung LIU, Miao-Li County (TW); Chien-Wen LIN, Miao-Li County (TW); Yu-Yuan YEH, Miao-Li County (TW); Chen-Ting HUANG, Miao-Li County (TW); Hui-Ching YANG, Miao-Li County (TW); Chen-Chia HSU, Miao-Li County (TW)

(73) Assignee: INNOLUX CORPORATION, Miao-Li County (TW)

(21) Appl. No.: 14/479,834

(22) Filed: Sep. 8, 2014

(30) Foreign Application Priority Data
Sep. 9, 2013 (TW) 102132396

(51) Int. Cl. G06K 9/00; G01K 13/00

(52) U.S. Cl. CPC G06K 9/0002; G01K 13/00
USPC 374/45

(57) ABSTRACT

An apparatus for identifying morphology comprises a substrate, a driving circuit, a readout circuit and an identifying circuit. The substrate comprises temperature sensors each comprising a sensing transistor. The driving circuit selects at least one of the transistors as a target sensing transistor, and outputs a driving signal to the target sensing transistor to heat the target sensing transistor in a heating period. The target sensing transistor senses a temperature change to generate a sensing signal in a sensing period after the heating period. The readout circuit reads the sensing signal, and the identifying circuit identifies the morphology according to the sensing signal.

This application claims the benefit of Taiwan application Serial No. 102132396, filed Sep. 9, 2013, the subject matter of which is incorporated herein by reference.

### BACKGROUND OF THE INVENTION

1. Field of the Invention

The invention relates in general to an electronic device, and more particularly to an apparatus for identifying morphology.

2. Description of the Related Art

Phase measurement interferometry (PMI) and atomic force microscope (AFM) are two known morphology identifying techniques. The PMI usually generates interference patterns through the interaction between light beams and an object surface, and detects the interference patterns, which can be used to construct the morphology. The PMI usually detects the interference patterns using an area scan camera.

Most of the AFMs adopt probes with tip radii of several nanometers. The probe is used to contact a to-be-tested object surface to perform the nano-structure measurement on the surface. Then, undulating changes of a cantilever beam in an AFM system are measured according to an optical lever principle, so that the interaction between the to-be-tested object and the probe on the tip end of the cantilever beam can be obtained. However, the PMI and the AFM have the complicated technology and the high prices. In addition, the PMI and the AFM are not portable, and have the insufficient utility. So, it is difficult for the PMI and the AFM to be applied to the fingerprint identification.

With the flourishing development of the technology, more and more electronic devices, such as mobile phones, personal digital assistants (PDAs), digital cameras, personal computers, notebook computers and the like, have become essential tools in the human's life. These electronic devices often store the very important information, such as phone books, photos, documents and the like. Once these electronic devices are lost or stolen, the information stored therein may be improperly used by others. Because the fingerprint has the relatively high unity, more and more electronic devices use the fingerprint identifying apparatus to identify the users. After the fingerprint identifying apparatus records the user's fingerprint, the user needs not to remember the specific password. Therefore, the risk that the password is stolen or cracked can be avoided.

### SUMMARY OF THE INVENTION

The invention is directed to an apparatus for identifying morphology.

According to the present invention, an apparatus for identifying morphology is provided. The apparatus for identifying morphology comprises a substrate, a driving circuit, a readout circuit and an identifying circuit. The substrate comprises temperature sensors each comprising a sensing transistor. The driving circuit selects at least one of the sensing transistors as a target sensing transistor, and outputs a driving signal to the target sensing transistor to heat the target sensing transistor in a heating period. The target sensing transistor senses a temperature change to generate a sensing signal in a sensing period after the heating period. The readout circuit reads the sensing signal, and the identifying circuit identifies the morphology according to the sensing signal.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows the architecture of an apparatus for identifying morphology according to a first embodiment.

FIG. 2 is a schematic view showing first temperature sensors.

FIG. 3 is a partial schematic view showing a substrate according to the first embodiment.

FIG. 4 shows characteristic curves each representing a channel current Ids versus a voltage difference Vgs of a NMOS FET.

FIG. 5 shows a characteristic curve representing a threshold voltage Vth of the NMOS FET versus a temperature.

FIG. 6 shows a characteristic curve representing a cut-off current Ioff of the NMOS FET and the temperature.

FIG. 7 shows characteristic curves each representing a voltage versus a current of a diode.

FIG. 8 shows a characteristic curve representing a turn-on voltage Von of the diode and the temperature.

FIG. 9 is a partial schematic view showing a substrate according to a second embodiment.

FIG. 10 is a partial schematic view showing a substrate according to a third embodiment.

FIG. 11 is a partial schematic view showing a substrate according to a fourth embodiment.

FIG. 12 is a partial schematic view showing a substrate according to a fifth embodiment.

FIG. 13 is a partial schematic view showing a substrate according to a sixth embodiment.

FIG. 14 is a partial schematic view showing a substrate according to a seventh embodiment.

FIG. 15 is a partial schematic view showing a substrate according to an eight embodiment.

FIG. 16 is a partial schematic view showing a substrate according to a ninth embodiment.

FIG. 17 shows a signal timing chart according to the ninth embodiment.

### DETAILED DESCRIPTION OF THE INVENTION

### First Embodiment

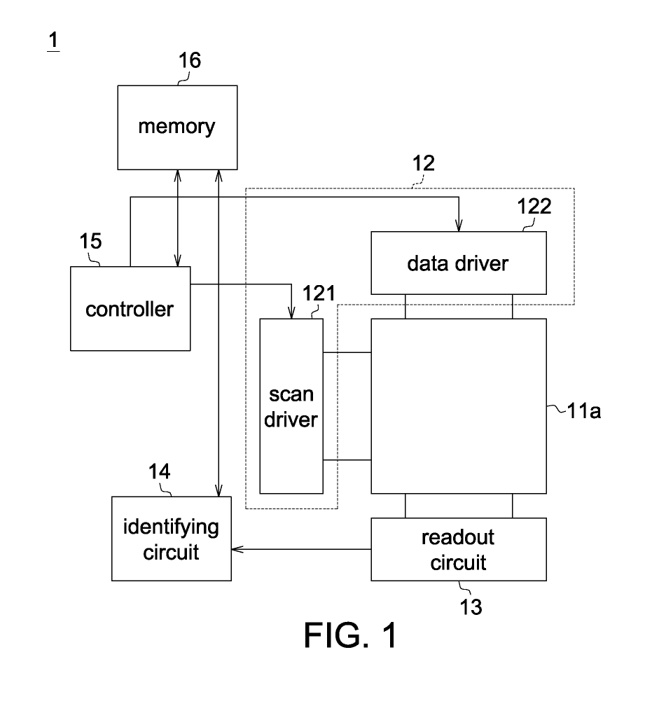

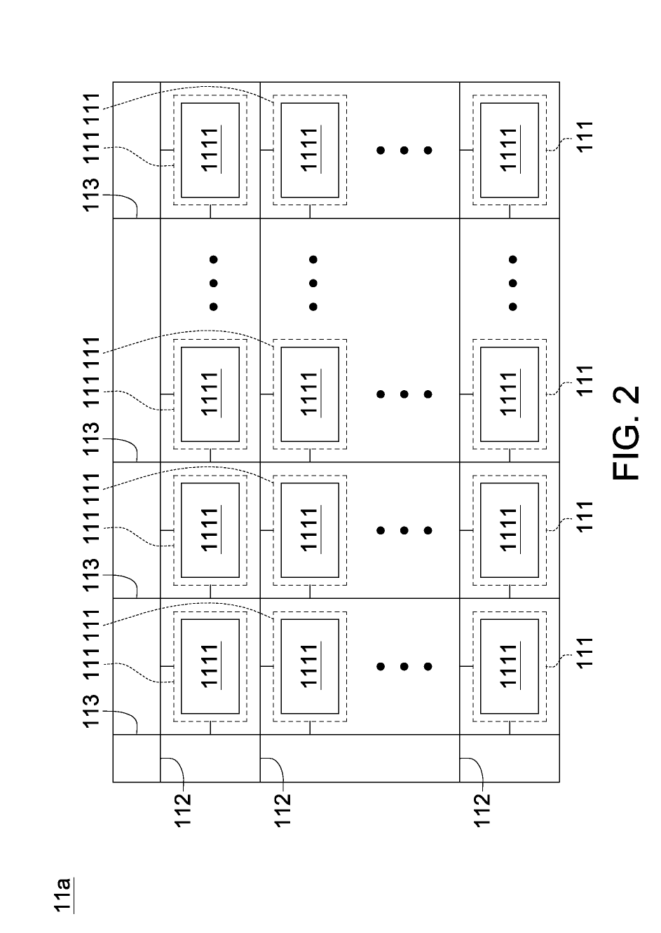

FIG. 1 shows the architecture of an apparatus for identifying morphology according to a first embodiment. FIG. 2 is a schematic view showing first temperature sensors. Referring to FIGS. 1 and 2, the apparatus 1 for identifying morphology is a fingerprint identifier, for example, and comprises a substrate 11a, a driving circuit 12, a readout circuit 13, an identifying circuit 14, a controller 15 and a memory 16. The driving circuit 12, the readout circuit 13 and the identifying circuit 14 may further be formed on the substrate 11a. The substrate 11a comprises temperature sensors 111, scan lines 112 and data lines 113. The temperature sensor 111 comprises a sensing transistor 1111, which is a metal-oxide-semiconductor field-effect-transistor (MOSFET) or a bipolar junction transistor (BJT). The controller 15 controls the driving circuit 12, and the memory 16 stores an identification result of the identifying circuit 14. The driving circuit 12 comprises a scan driver 121 and a data driver 122. The scan driver 121 is coupled to the scan lines 112, while the data driver 122 is coupled to the data lines 113.

The scan driver 121 and the data driver 122 select at least one of the sensing transistors 1111 as a target sensing transistor, and firstly output a driving signal to the target sensing transistor to heat the target sensing transistor in a heating period. The driving signal is a voltage signal or a current signal, for example. Then, the target sensing transistor senses a temperature change to generate a sensing signal in a sensing period after the heating period, wherein the sensing signal is a voltage signal or a current signal, for example. The readout circuit 13 reads the sensing signal, and the identifying circuit 14 identifies the morphology according to the sensing signal. The morphology is, for example, fingerprint ridges, fingerprint valleys or fingerprints. When the driving signal is the voltage signal, the sensing signal is the current signal. On the contrary, when the driving signal is the current signal, the sensing signal is the voltage signal.

It is to be specified that the sensing transistor 1111 can be selected, addressed and read, and can also function as a heater. In addition, because the thermoconductive medium of the fingerprint ridge is the human body having the heat conductivity coefficient of about 0.58 W/mk, and the thermoconductive medium of the fingerprint valley is air having the heat conductivity coefficient of about 0.024 W/mk, the difference between the heat conductivity coefficient of the human body and the air is extremely large. Therefore, the temperature change of the fingerprint ridge sensed by the target sensing transistor is larger than the temperature change of the fingerprint valley sensed by the target sensing transistor. So, the identifying circuit 14 can identify the portion, sensed by the target sensing transistor, as the fingerprint ridge or the fingerprint valley according to different sensing signals.

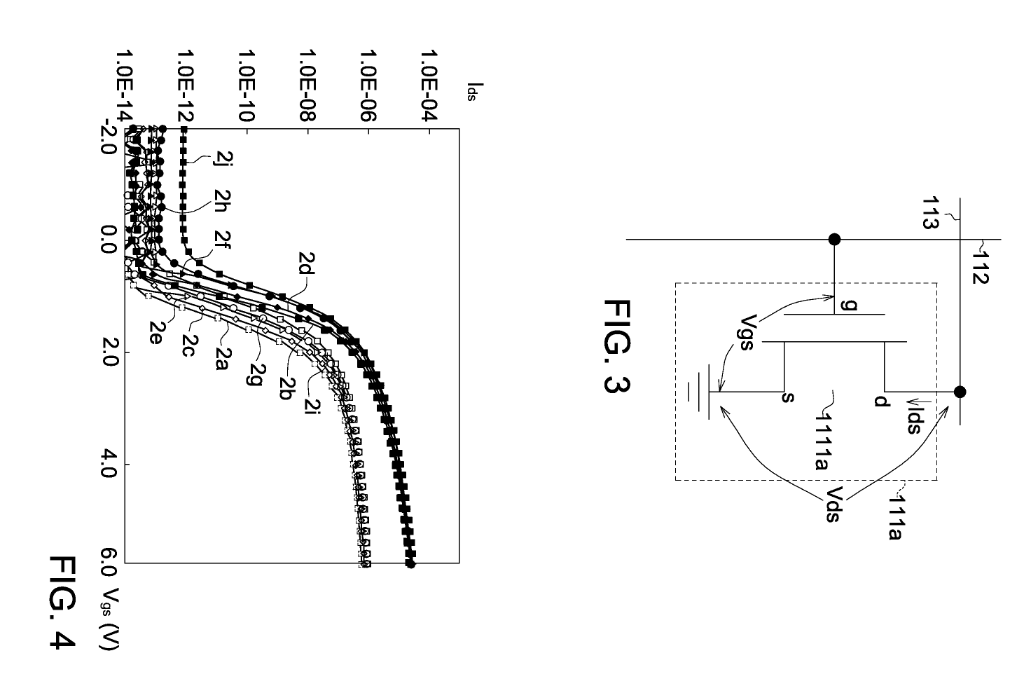

FIG. 3 is a partial schematic view showing a substrate according to the first embodiment. Referring to FIG. 3, the temperature sensors may have various implemented aspects. For example, FIG. 3 shows a temperature sensor 111a as an example. In the following example, the sensing transistor of the temperature sensor 111a is a N-type MOS FET (NMOS FET) 1111a having a gate g connected to the scan line 112, a drain d connected to the data line 113, and a source s connected to the ground. Although the NMOS FET 1111a serves as an example in FIG. 3, the practical application is not restricted thereto. That is, a P-type MOS FET (PMOS FET) may also be used as the sensing transistor.

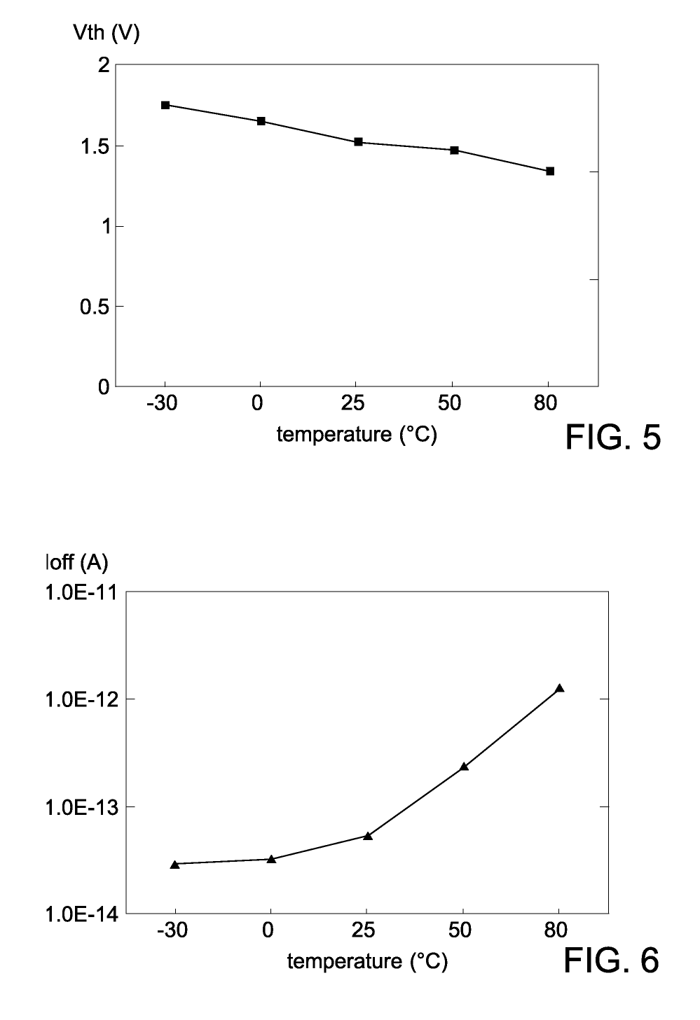

Please refer to FIGS. 4 to 6. FIG. 4 shows characteristic curves each representing a channel current Ids versus a voltage difference Vgs of a NMOS FET. FIG. 5 shows a characteristic curve representing a threshold voltage Vth of the NMOS FET versus a temperature. FIG. 6 shows a characteristic curve representing a cut-off current Ioff of the NMOS FET and the temperature. As shown in FIG. 4, when the temperature is −30° C. and the voltage difference Vds is 0.1V, the relationship between the channel current Ids and the voltage difference Vgs is represented by the curve 2a; when the temperature is −30° C. and the voltage difference Vds is 10.1V, the relationship between the channel current Ids and the voltage difference Vgs is represented by the curve 2b; when the temperature is 0° C. and the voltage difference Vds is 0.1V, the relationship between the channel current Ids and the voltage difference Vgs is represented by the curve 2c; when the temperature is 0° C. and the voltage difference Vds is 10.1V, the relationship between the channel current Ids and the voltage difference Vgs is represented by the curve 2d; when the temperature is 25° C. and the voltage difference Vds is 0.1V, the relationship between the channel current Ids and the voltage difference Vgs is represented by the curve 2e; when the temperature is 25° C. and the voltage difference Vds is 10.1V, the relationship between the channel current Ids and the voltage difference Vgs is represented by the curve 2f; when the temperature is 50° C. and the voltage difference Vds is 0.1V, the relationship between the channel current Ids and the voltage difference Vgs is represented by the curve 2g; when the temperature is 50° C. and the voltage difference Vds is 10.1V, the relationship between the channel current Ids and the voltage difference Vgs is represented by the curve 2h; when the temperature is 80° C. and the voltage difference Vds is 0.1V, the relationship between the channel current Ids and the voltage difference Vgs is represented by the curve 2i; and when the temperature is 80° C. and the voltage difference Vds is 10.1V, the relationship between the channel current Ids and the voltage difference Vgs is represented by the curve 2j. It can be seen that when the voltage difference Vgs is fixed, the channel current Ids changes with the temperature change. Consequently, when the driving signal outputted in the heating period is the drain voltage, the sensing signal generated in the sensing period is the channel current Ids.

FIG. 4 may further be represented by FIGS. 5 and 6. As shown in FIG. 5, the threshold voltage Vth changes with the temperature change, and the threshold voltage Vth decreases with the temperature rise. Consequently, when the driving signal outputted in the heating period is the channel current Ids, the sensing signal generated in the sensing period is the threshold voltage Vth. As shown in FIG. 6, the cut-off current Ioff changes with the temperature change, and the cut-off current Ioff increases with the temperature rise. Consequently, when the driving signal outputted in the heating period is the gate voltage, the sensing signal generated in the sensing period is the cut-off current Ioff.

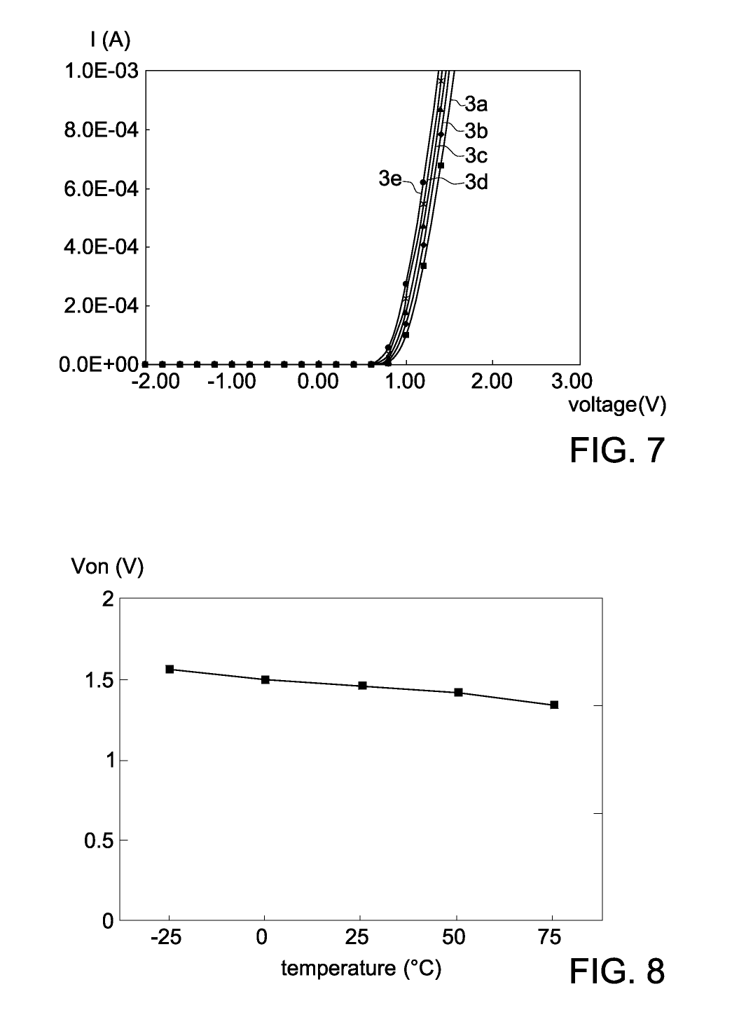

Please refer to FIGS. 5, 7 and 8. FIG. 7 shows characteristic curves each representing a voltage versus a current of a diode. FIG. 8 shows a characteristic curve representing a turn-on voltage Von of the diode and the temperature. When the temperature is −25° C., the relationship between the voltage and the current I of the diode is represented by the curve 3a; when the temperature is 0° C., the relationship between the voltage and the current I of the diode is represented by the curve 3b; when the temperature is 25° C., the relationship between the voltage and the current I of the diode is represented by the curve 3c; when the temperature is 50° C., the relationship between the voltage and the current I of the diode is represented by the curve 3d; and when the temperature is 75° C., the relationship between the voltage and the current I of the diode is represented by the curve 3e. It can be seen that the turn-on voltage Von of the diode changes with the temperature change, as shown in FIG. 8, and the turn-on voltage Von of the diode decreases with the temperature rise. As shown in FIG. 5, it can be further derived that the temperature coefficient of the NMOS FET is that the threshold voltage Vth decreases 3.75 mV as the temperature rises 1° C. As shown in FIG. 8, it is derived that the temperature coefficient of the diode is that the turn-on voltage Von decreases 1.8 mV as the temperature rises 1° C. It can be seen that the change of the threshold voltage Vth with the temperature change would be greater than the change of the turn-on voltage Von with the temperature change. It is obvious that the MOS FET is very suitable for the temperature sensor.

### Second Embodiment

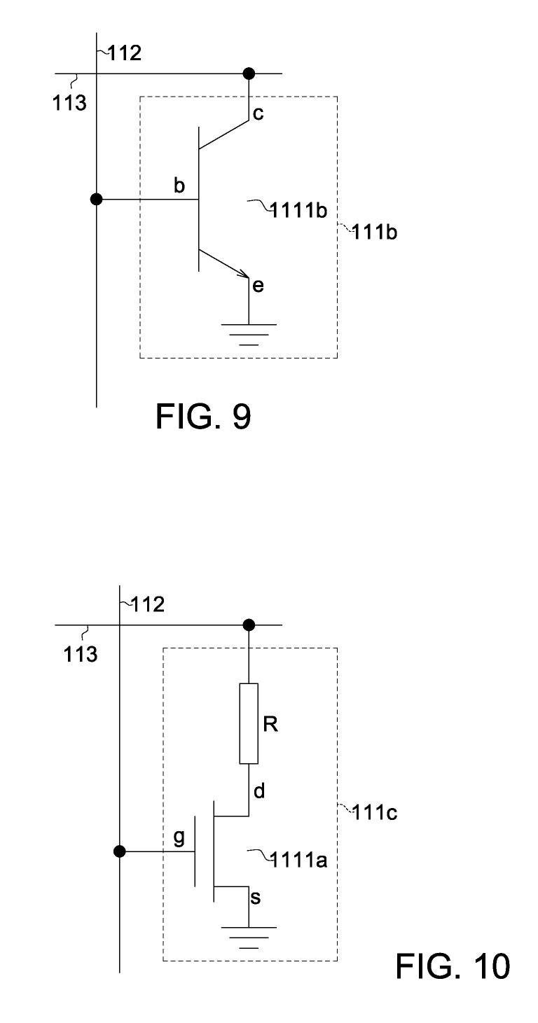

FIG. 9 is a partial schematic view showing a substrate according to a second embodiment. Referring to FIG. 9, the difference between the second and first embodiments resides in that FIG. 9 shows a temperature sensor 111b as an example. The temperature sensor 111b comprises a NPN transistor 1111b, which has a base b connected to the scan line 112, a collector c connected to the data line 113, and an emitter e connected to the ground. Although FIG. 9 shows the NPN transistor 1111b as the example to be described, the practical application is not restricted thereto. Instead, a PNP transistor may also serve as the sensing transistor.

### Third Embodiment

FIG. 10 is a partial schematic view showing a substrate according to a third embodiment. Referring to FIG. 10, the difference between the third and first embodiments resides in that FIG. 10 shows the temperature sensor 111c as the example to be described. In addition to the NMOS FET 1111a, the temperature sensor 111c further comprises a resistor R, which has one terminal connected to the data line 113, and the other terminal connected to the drain d of the NMOS FET 1111a. The gate g of the NMOS FET 1111a is connected to the scan line 112, and the source s of the NMOS FET 1111a is connected to the ground.

### Fourth Embodiment

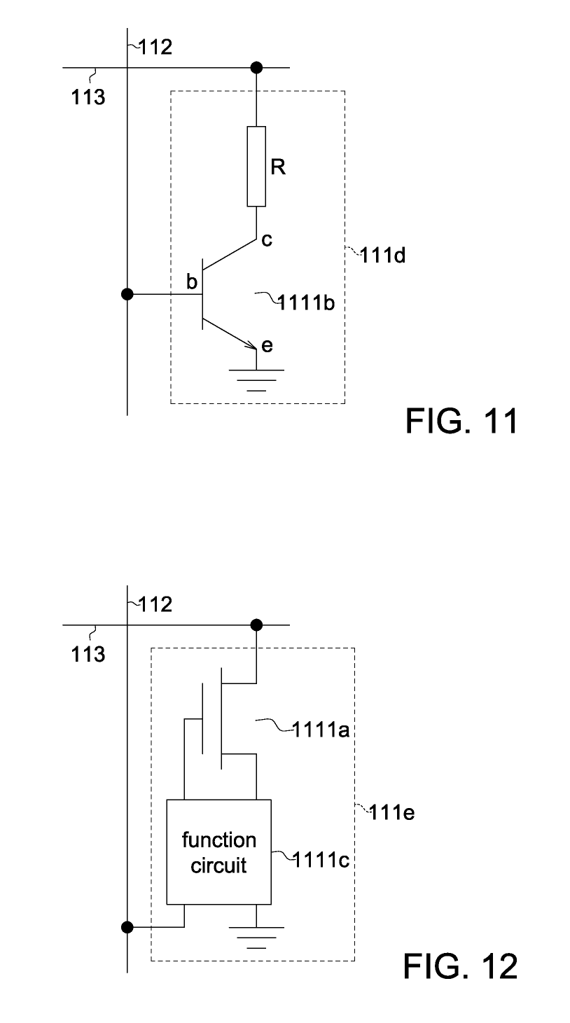

FIG. 11 is a partial schematic view showing a substrate according to a fourth embodiment. Referring to FIG. 11, the difference between the fourth and first embodiments resides in that FIG. 11 shows a temperature sensor 111d as the example to be described. In addition to the NPN transistor 1111b, the temperature sensor 111d further comprises a resistor R having one terminal connected to the data line 113, and the other terminal connected to the collector c of the NPN transistor 1111b. The base b of the NPN transistor 1111b is connected to the scan line 112, and the emitter e of the NPN transistor 1111b is connected to the ground.

### Fifth Embodiment

FIG. 12 is a partial schematic view showing a substrate according to a fifth embodiment. Referring to FIG. 12, the difference between the fifth and first embodiments resides in that FIG. 12 shows a temperature sensor 111e as the example to be described. In addition to the NMOS FET 1111a, the temperature sensor 111e further comprises a function circuit 1111c connected to the NMOS FET 1111a. The function circuit 1111c is, for example, an amplifier circuit, a compensation circuit or a filter circuit, wherein the amplifier circuit, the compensation circuit or the filter circuit performs signal amplification, signal compensation or signal filtering on the sensing signal.

### Sixth Embodiment

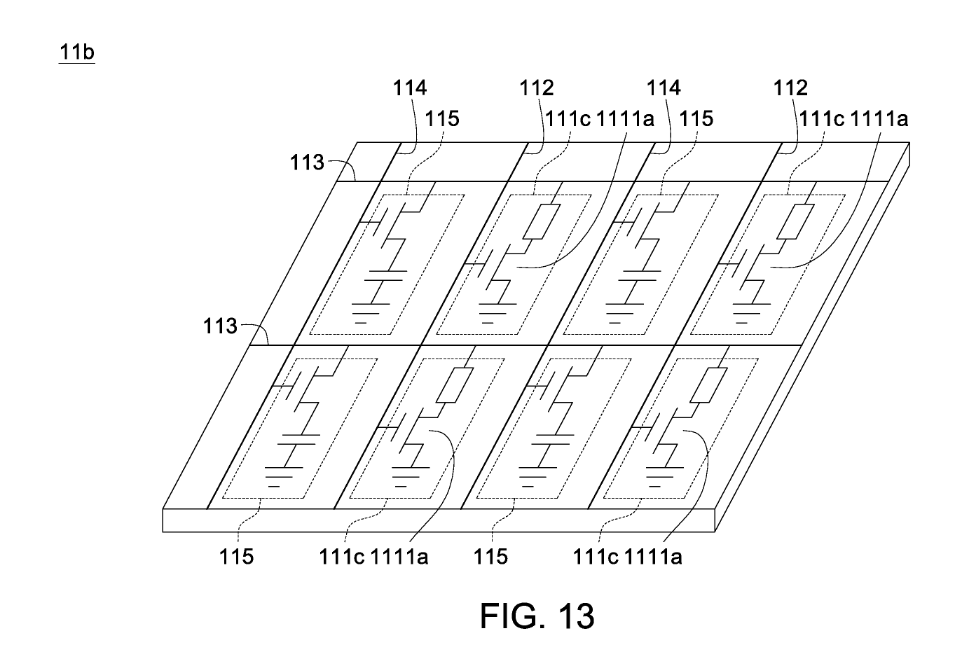

Please refer to FIGS. 1 and 13. FIG. 13 is a partial schematic view showing a substrate according to a sixth embodiment. The main difference between the sixth and first embodiments resides in that FIG. 13 shows a substrate 11b as the example to be described. The substrate 11b comprises scan lines 112, data lines 113, scan lines 114, temperature sensors 111c and pixels 115, wherein the temperature sensors 111c and the pixels 115 are arranged alternately. The temperature sensor 111c comprises a NMOS FET 1111a. The scan line 112 is connected to the NMOS FET 1111a to control the NMOS FET 1111a to turn on or cut-off. The scan line 114 is connected to the pixel 115 and controls the pixel 115 to display an image or not. The data line 113 is connected to the NMOS FET 1111a and the pixel 115.

### Seventh Embodiment

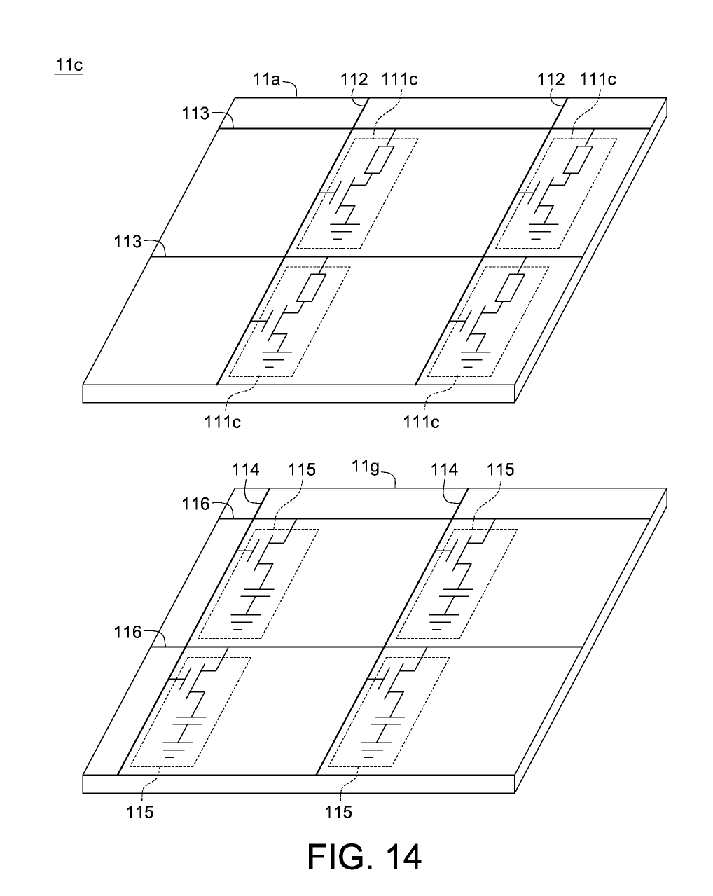

Please refer to FIGS. 1 and 14. FIG. 14 is a partial schematic view showing a substrate according to a seventh embodiment. The difference between the seventh and first embodiments resides in that FIG. 14 shows a substrate 11c as the example to be described. The substrate 11c is composed of two independent substrates 11a and 11g, wherein the substrate 11a performs sensing and the substrate 11g performs displaying. The substrate 11c comprises scan lines 114, pixels 115 and data lines 116. The pixels 115 are connected to the data lines 116 and controlled by the scan lines 114. The scan lines 114 and the scan lines 112 may be connected to the same scan driver 121, and the data lines 116 and the data lines 113 may be connected to the same data driver 122. The scan driver 121 and the data driver 122 drive the pixels 115, wherein the arrangement of the two independent substrates 11a and 11g is not the key feature, and detailed descriptions thereof will be omitted.

### Eighth Embodiment

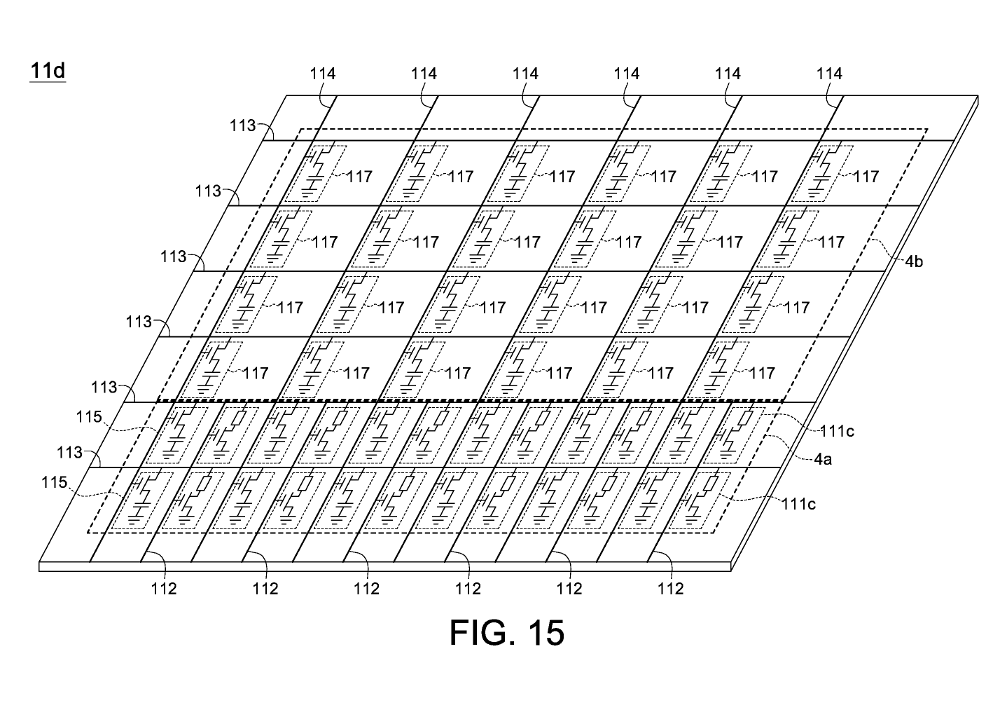

Please refer to FIG. 1 and FIG. 15. FIG. 15 is a partial schematic view showing a substrate according to an eight embodiment. The difference between the eighth and first embodiments resides in that FIG. 15 shows a substrate 11d as the example to be described. The substrate 11d is a substrate having a display zone, which may be divided into a display region 4a and a display region 4b. The substrate 11d comprises temperature sensors 111c, pixels 115 and pixels 117, wherein the temperature sensors 111c, the pixels 115 and the pixels 117 are connected to the data lines 113. The pixels 115 and the temperature sensors 111c are arranged alternately and are disposed in the display region 4a of the substrate 11d. The pixels 117 are disposed in the display region 4b of the substrate 11d. The pixels 115 and the pixels 117 are controlled by the scan lines 114, and the temperature sensors 111c are controlled by the scan lines 112.

### Ninth Embodiment

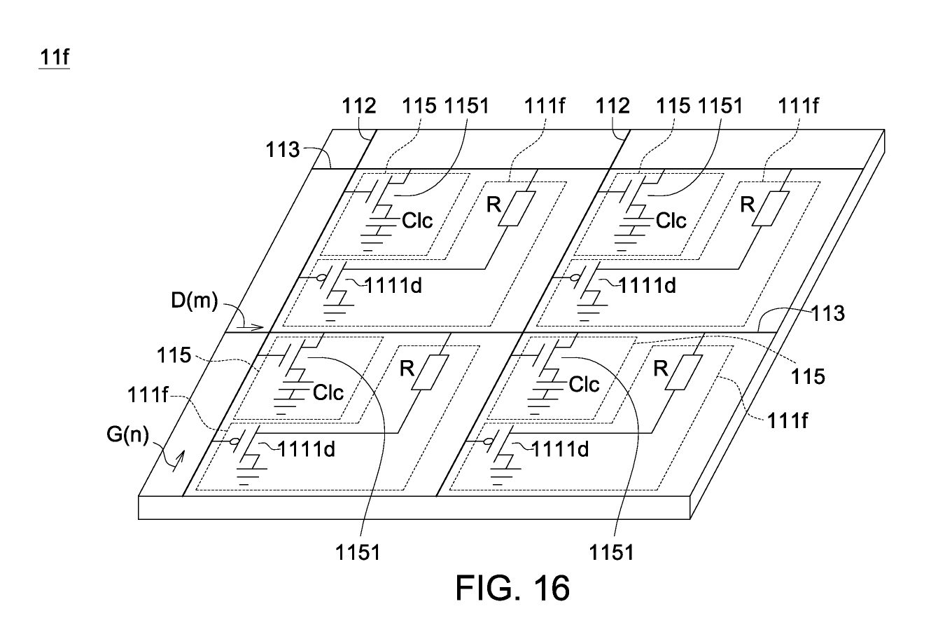

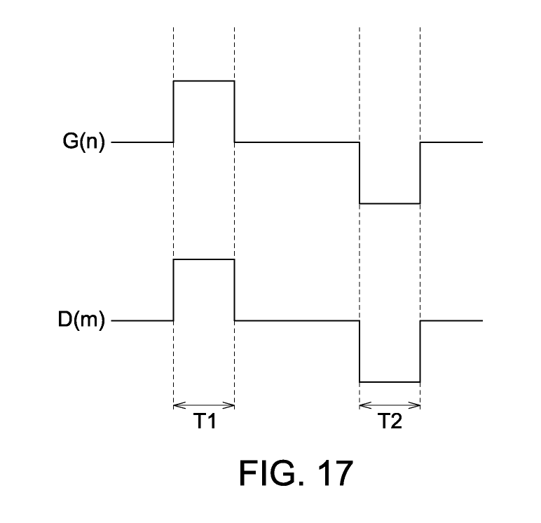

Please refer to FIGS. 1, 16 and 17. FIG. 16 is a partial schematic view showing a substrate according to a ninth embodiment. FIG. 17 shows a signal timing chart according to the ninth embodiment. The difference between the ninth and first embodiments resides in that FIG. 15 shows a substrate 11f as the example to be described. The substrate 11f comprises temperature sensors 111f, scan lines 112, data lines 113 and pixels 115. The temperature sensor 111f comprises a PMOS FET 1111d and a resistor R. The resistor R has one terminal connected to the data line 113, and the other terminal connected to the PMOS FET 1111d. The pixel 115 comprises an NMOS FET 1151 and a liquid crystal capacitor Clc. The NMOS FET 1151 is connected to the liquid crystal capacitor Clc, the scan line 112 and the data line 113. The NMOS FET 1151 decides whether to write a data signal D(m) on the data line 113 to the liquid crystal capacitor Clc according to a scan signal G(n) on the scan line 112. The PMOS FET 1111d is connected to the scan line 112 and the data line 113, and is controlled by the scan signal G(n) on the scan line 112 and the data signal D(m) on the data line 113.

The driving circuit 12 selects at least one of the NMOS FETs 1151 as a target display transistor, and selects at least one of the PMOS FETs 1111d as a target sensing transistor. The target display transistor is controlled by the positive voltage of the scan signal G(n) to turn on in the period T1, and writes the data signal D(m) having the positive polarity to the liquid crystal capacitor Clc. The PMOS FET 1111d is controlled by the negative voltage of the scan signal G(n) to turn on in the period T2, and receives the data signal D(m) having the negative polarity.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for identifying morphology, comprising:
a first substrate, comprising a plurality of temperature sensors each comprising a sensing transistor;
a driving circuit for selecting at least one of the sensing transistors as a target sensing transistor, and outputting a driving signal to the target sensing transistor to heat the target sensing transistor in a heating period, wherein the target sensing transistor senses a temperature change to generate a sensing signal in a sensing period after the heating period;
a readout circuit for reading the sensing signal; and
an identifying circuit for identifying the morphology according to the sensing signal.

2. The apparatus according to claim 1, wherein the sensing transistor is a metal-oxide-semiconductor field-effect-transistor (MOSFET).

3. The apparatus according to claim 1, wherein the sensing transistor is a bipolar junction transistor (BJT).

4. The apparatus according to claim 1, wherein the temperature sensor further comprises a resistor connected to the sensing transistor.

5. The apparatus according to claim 1, wherein the temperature sensor further comprises a function circuit connected to the sensing transistor.

6. The apparatus according to claim 5, wherein the function circuit is selected from a group consisting of an amplifier circuit, a compensation circuit and a filter circuit.

7. The apparatus according to claim 2, wherein the driving signal is a voltage signal, and the sensing signal is a current signal.

8. The apparatus according to claim 7, wherein the voltage signal is a drain voltage, and the current signal is a channel current.

9. The apparatus according to claim 2, wherein the driving signal is a current signal, and the sensing signal is a voltage signal.

10. The apparatus according to claim 9, wherein the current signal is a channel current, and the voltage signal is a drain voltage.

11. The apparatus according to claim 1, wherein the driving circuit, the readout circuit and the identifying circuit are formed on the first substrate.

12. The apparatus according to claim 1, wherein the first substrate further comprises a plurality of first pixels and a plurality of second pixels, the first pixels and the temperature sensors are arranged alternately and disposed in a first display region of the first substrate, and the second pixels are disposed in a second display region of the first substrate.

13. The apparatus according to claim 1, further comprising a second substrate, wherein the second substrate comprises a plurality of pixels, and the driving circuit drives the pixels.

14. The apparatus according to claim 1, wherein the first substrate further comprises:
a plurality of scan lines connected to the sensing transistors, respectively; and
a plurality of data lines connected to the sensing transistors, respectively.

15. The apparatus according to claim 1, wherein the first substrate further comprises:
a plurality of pixels;
a plurality of first scan lines connected to the sensing transistors, respectively;
a plurality of second scan lines connected to the pixels, respectively; and
a plurality of data lines connected to the sensing transistors and the pixels, respectively.

16. The apparatus according to claim 1, wherein the first substrate further comprises:
a plurality of pixels;
a plurality of scan lines connected to the sensing transistors and the pixels, respectively; and
a plurality of data lines connected to the sensing transistors and the pixels, respectively.

17. The apparatus according to claim 16, wherein each of the pixels comprises a NMOS FET, each of the sensing transistors is a PMOS FET, the driving circuit selects one of the NMOS FETs as a target display transistor, the target display transistor is controlled by a positive voltage to turn on in a first period, and the target sensing transistor is controlled by a negative voltage to turn on in a second period different from the first period.
